(19) United States
(12) Patent Application Publication
(10) Pub. No.: US 2012/0173022 A1
(43) Pub. Date: Jul. 5, 2012

(54) CONTROL APPARATUS OF AMMONIA LOADING AMOUNT FOR SCR SYSTEM AND CONTROL METHOD FOR THE SAME

(75) Inventor: Ji Ho Cho, Yongin-city (KR)

(73) Assignee: Hyundai Motor Company, Seoul (KR)

(21) Appl. No.: 13/419,890

(22) Filed: Mar. 14, 2012

Related U.S. Application Data
(62) Division of application No. 12/622,199, filed on Nov. 19, 2009.

(30) Foreign Application Priority Data
Sep. 7, 2009 (KR) 10-2009-0084179

(51) Int. Cl. G05B 21/00

(52) U.S. Cl. 700/266

(57) ABSTRACT

A control method of ammonia loading amount for SCR system controls ammonia loading amount according to temperature difference along length direction of a SCR catalyst. The control method includes receiving data from sensors disposed forward and rearward of a SCR catalyst, and dividing SCR catalyst into a plurality of blocks according to temperatures of an inlet and outlet of the SCR catalyst, wherein the blocks have each temperature ranges, calculating required ammonia amount of each block of the SCR catalyst, calculating total required ammonia amount of the SCR catalyst by adding required ammonia amount of each block of the SCR catalyst and controlling the ammonia loading amount for SCR system.

### CROSS-REFERENCE TO RELATED APPLICATION

This application is a Divisional of U.S. patent application Ser. No. 12/622,199, filed Nov. 19, 2009, which claims priority to Korean Patent Application Number 10-2009-0084179 filed Sep. 7, 2009, the entire contents of which application is incorporated herein for all purposes by this reference.

### BACKGROUND OF THE INVENTION

1. Field of the Invention

The present invention relates to a control apparatus of ammonia loading amount for SCR system and control method for the same. More particularly, the present invention relates to a control apparatus of ammonia loading amount for SCR system and control method for the same according to temperature difference along length direction of a SCR catalyst.

2. Description of Related Art

Generally, a vehicle with a diesel engine uses a variety of post-processing technology to eliminate NOx, CO, THC and Particulate Matters (PM) and so on for satisfying emission control regulations such as Euro 5, Euro 6, and US Tier II Bin 5.

The post-processing technology includes a DOC (Diesel Oxidation Catalyst) disposed near an engine to oxidize carbon monoxide CO, a DPF (Diesel Particulate Filter) to trap PM, a SCR catalyst to reduces nitrogen oxides (NOx) and so on.

The SCR catalyst that hydrolyzes aqueous urea to ammonia (NH3), which, in turn, reduces nitrogen oxides (NOx) and accelerates a reaction between a monoxide and ammonia in a case that oxygen exists. Thus, the ammonia-SCR apparatus has been applicable to a diesel exhaust apparatus.

A dosing module is disposed forward of the SCR catalyst and injects urea for maintaining NOx reducing rate, and ammonia generated by evaporation and resolution of the urea is loaded to the SCR catalyst. Wherein, loading amount of the ammonia is inverse proportion to SCR catalyst temperature.

In a conventional vehicle, it is assumed that temperature inside of the SCR catalyst is uniform, and thus average temperature of inlet and outlet of the SCR catalyst is applied to a predetermined map to predict the loadable ammonia amount per volume of the SCR catalyst and then target ammonia loading amount is determined.

And then, required ammonia amount of the SCR catalyst is determined according to differences between the target ammonia loading amount of the SCR catalyst and current loaded ammonia amount of the SCR catalyst.

In the SCR catalyst, when temperature of the SCR catalyst is relatively low, loading process is slowly progressed but loadable amount of the ammonia is increased so that differences between loaded ammonia amount in the inlet and outlet of the SCR catalyst is increased. However, when temperature of the SCR catalyst is relatively high, loading process is rapidly progressed but loadable amount of the ammonia is relatively reduced so that differences between loaded ammonia amount in the inlet and outlet of the SCR catalyst is decreased.

Thus, variation of the temperature of the SCR catalyst may deteriorate NOx reducing rate or purifying rate according to a conventional SCR system assuming that temperature inside of the SCR catalyst is uniform.

For example, NOx reduction or NOx purification is stably progressed in front portion of the SCR catalyst, but NOx slip may occur in rear portion of the SCR catalyst.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention provide for a control an apparatus of ammonia loading amount for SCR system and control method for the same may control urea injecting amount according to temperature difference along length direction of a SCR catalyst for maximizing the reduction rate of nitrogen oxide and prevents slip of ammonia as a consequence of precisely calculating the amount of ammonia loaded in the SCR catalyst.

A control apparatus of ammonia loading amount for SCR system according to various embodiments of the present invention may include a SCR catalyst reducing NOx with the loaded ammonia to nitrogen (N₂), a first and second temperature sensor sensing temperature at inlet and outlet of the SCR catalyst respectively, a NOx sensor detecting nitrogen oxide amount inflowing into the SCR catalyst and a control portion that divides the SCR catalyst into a plurality of block having different temperature according to temperatures of the inlet and outlet of the SCR catalyst, calculates required ammonia amount of each block of the SCR catalyst, calculates total required ammonia amount of the SCR catalyst by adding the required ammonia amount of each block of the SCR catalyst and controls the ammonia loading amount for SCR system.

The control portion may calculate loadable ammonia amount of each block of the SCR catalyst from a predetermined map according to the temperature of each block, the control portion calculates current loaded ammonia amount of the SCR catalyst using inflowing ammonia amount into the SCR catalyst, inflowing NOx amount into the SCR catalyst and reducing NOx rate, and the control portion calculates the required ammonia amount of each block of the SCR catalyst from difference of the loadable ammonia amount of each block and current loaded ammonia amount.

The control portion may divide the SCR catalyst into a plurality of block according to a predetermined temperature model along length direction of the SCR catalyst.

A control method of ammonia loading amount for SCR system according to various embodiments of the present invention may include receiving data from sensors disposed forward and rearward of a SCR catalyst, dividing SCR catalyst into a plurality of block according to temperatures of an inlet and outlet of the SCR catalyst, wherein the blocks have each temperature ranges, calculating required ammonia amount of each block of the SCR catalyst, calculating total required ammonia amount of the SCR catalyst by adding required ammonia amount of each block of the SCR catalyst and controlling the ammonia loading amount for SCR system.

The dividing SCR catalyst into a plurality of block may be occurred according to a predetermined temperature model along length direction of the SCR catalyst.

The calculating required ammonia amount of each block of the SCR catalyst may include calculating loadable ammonia amount of each block of the SCR catalyst from a predetermined map according to the temperature of each block, calculating current loaded ammonia amount of the SCR catalyst using inflowing ammonia amount into the SCR catalyst, inflowing NOx amount into the SCR catalyst and reducing NOx rate and calculating the required ammonia amount of each block of the SCR catalyst from difference of the loadable ammonia amount of each block and current loaded ammonia amount.

The receiving data from sensors may include ammonia amount, resolved from urea supplying to the SCR catalyst, NOx amount within exhaust gas and temperature at inlet and outlet of the SCR catalyst respectively.

An apparatus of ammonia loading amount for SCR system and control method for the same according to various embodiments of the present invention may control urea injecting amount according to temperature difference along length direction of a SCR catalyst for maximizing the reduction rate of nitrogen oxide and prevents slip of ammonia as a consequence of precisely calculating the amount of ammonia loaded in the SCR catalyst.

Also, responsiveness according to exhaust condition change can be enhanced precisely calculating the amount of ammonia loaded in the SCR catalyst may be possible and injecting of the urea can be precisely controlled to generate ammonia.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic diagram of an exemplary control apparatus for ammonia loading amount of SCR system according to the present invention.

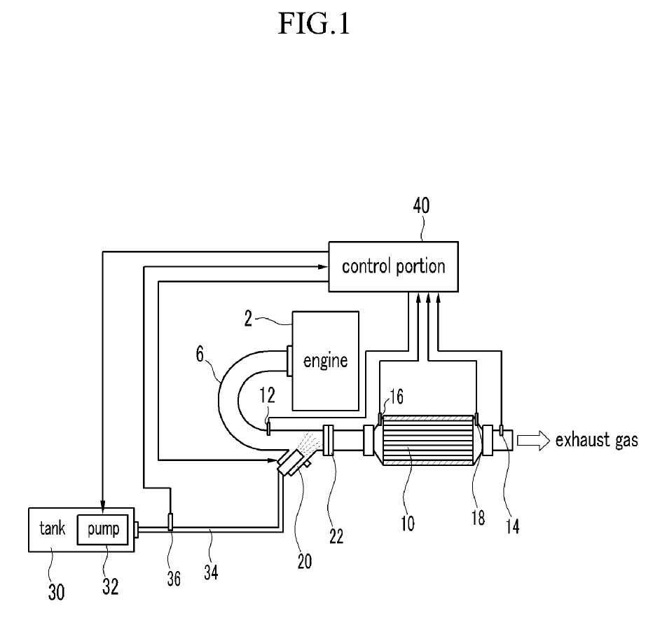

FIG. 2 is a flowchart of an exemplary control method for ammonia loading amount of SCR system according to the present invention.

FIG. 3 is a flowchart of control method of an axial direction reaction model module of FIG. 2.

FIG. 4 is a graph showing an exemplary ammonia loading amount along a SCR catalyst length direction according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A control apparatus for ammonia loading amount of SCR system according to various embodiments of the present invention includes an engine 2, an exhaust pipe 6 for discharging exhaust gas from the engine 2, a SCR catalyst 10, a first NOx sensor 12, a second NOx sensor 14, a first temperature sensor 16, a second temperature sensor 18, a dosing module 20, a mixer 22, a urea tank 30, a pump 32, urea supply line 34, a pressure sensor 36 and a control portion 40.

The SCR catalyst 10 may be made of a V₂O₅/TiO₂, Pt/Al₂O₃ or Zeolite, and is disposed on the exhaust pipe 6 connected with the engine 2 and reduces NOx with ammonia, which is included within urea injected from the dosing module 20, to nitrogen (N₂).

The first NOx sensor 12 is disposed forward of the dosing module 20, detects NOx amount within exhaust gas inflowing into the SCR catalyst 10 and transmits a corresponding signal to the control portion 40.

The second NOx sensor 14 is disposed rearward of the SCR catalyst 10, detects NOx amount within exhaust gas discharging from the SCR catalyst 10 and transmits a corresponding signal to the control portion 40.

The first temperature sensor 16 is disposed at inlet of the SCR catalyst 10, detects temperature of the inlet of the SCR catalyst 10 and transmits a corresponding signal to the control portion 40.

The second temperature sensor 18 is disposed at outlet of the SCR catalyst 10, detects temperature of the outlet of the SCR catalyst 10 and transmits a corresponding signal to the control portion 40.

The dosing module 20 operates injector by controlling of the control portion 40 and injects urea for generating ammonia required to the SCR catalyst 10.

The mixer 22 is disposed between the dosing module 20 and the SCR catalyst 10, splits the liquid urea and expedites decomposing urea into ammonia to mix the ammonia with the exhaust gas and thus ammonia generated by decomposing urea is uniformly loaded to the SCR catalyst 10.

The urea tank 30 supplies the liquid urea through the urea supply line 34 and the dosing module 20 to front of the SCR catalyst 10 by operation of the pump 32.

The pressure sensor 36 detects pressure within the urea supply line 34 transmits a corresponding signal to the control portion 40 for maintaining adequate pressure within the urea supply line 34 when the engine 2 is operated.

The control portion 40 divides the SCR catalyst 10 into a plurality of block (for example, N units can be applied and 5 units are drawn in the drawing) by applying reaction model module along length direction of the SCR catalyst 10 according to temperatures of the inlet and outlet of the SCR catalyst 10 and the control portion 40 calculates required ammonia amount of each block of the SCR catalyst 10.

Using reaction model module along length direction of the SCR catalyst, the required ammonia amount of each block of the SCR catalyst can be calculated.

The N units of blocks can divided into some section along the length direction of the SCR catalyst and each blocks have each temperature ranges.

The required ammonia amount of each block according to temperature difference can be calculated by applying each temperature (T.SCR) of each block into a map of loadable ammonia amount per volume and using substantial volume of each block.

The map of loadable ammonia amount per volume is determined by experiments.

Also, current loaded ammonia amount of the SCR catalyst 10 can be calculated by using inflowing ammonia amount (NH3.In) into the SCR catalyst 10, inflowing NOx amount (NOx.In) into the SCR catalyst and reducing NOx rate, and required ammonia amount of each block of the SCR catalyst 10 can be calculated from difference of the loadable ammonia amount of each block and current loaded ammonia amount.

And then, total required ammonia amount of the SCR catalyst 10 can be calculated by adding the required ammonia amount of each block of the SCR catalyst 10.

After calculating the total required ammonia amount of the SCR catalyst 10 and then injecting the urea amount from the dosing module 20 is controlled.

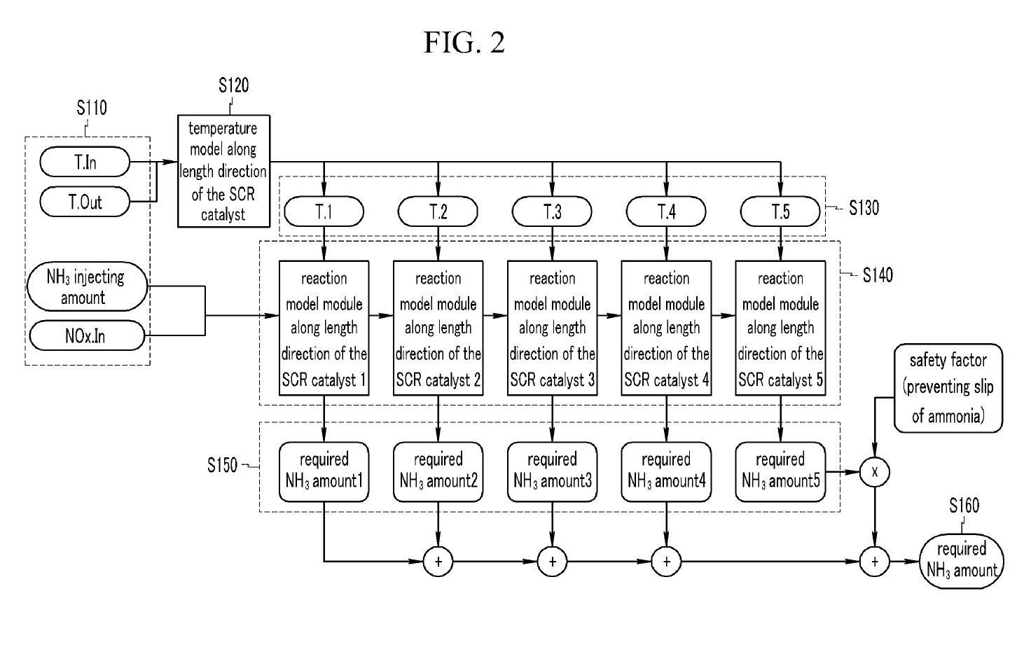

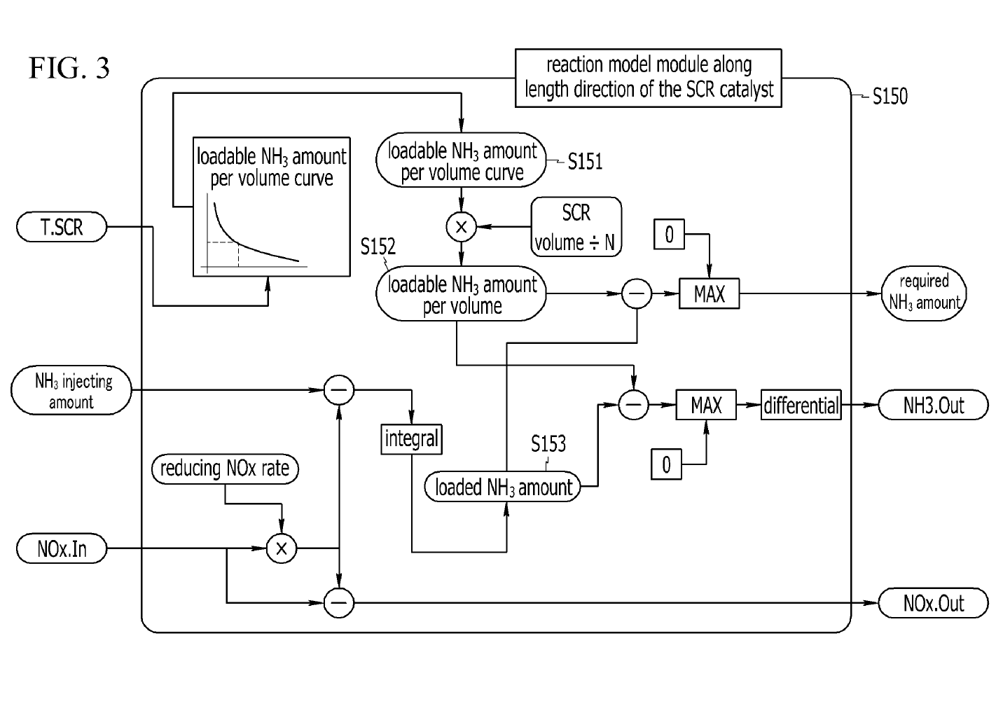

FIG. 2 is a flowchart of a control method for ammonia loading amount of SCR system according to various embodiments of the present invention and FIG. 3 is a flowchart of control method of an axial direction reaction model module of FIG. 2.

Hereinafter, controlling of ammonia loading amount of SCR system according to various embodiments of the present invention will be described.

Referring to FIG. 2 and FIG. 3, when the engine 2 stars, the control portion 40 receives data from sensors disposed forward and rearward of a SCR catalyst 10 for controlling ammonia loading amount (S110).

For example, the control portion 40 receives data such as the inlet temperature (T.In) of the SCR catalyst 10 from the first temperature sensor 16, the outlet temperature (T.Out) of the SCR catalyst 10 from the second temperature sensor 18, ammonia injection amount (NH3 injection amount) calculated using the injected urea liquid, and the NOx amount (NOx.In) inflowing the SCR catalyst 10 from the first NOx sensor 12.

And then, the temperatures of the inlet and outlet of the SCR catalyst 10 detected from the first and second temperature sensor 16 and 18 are applied to the reaction model module along length direction of the SCR catalyst (S120) and the SCR catalyst 10 is divided into N blocks (for example, 5 blocks) having each temperatures (T.1-T.5) (S130).

The reaction model module along length direction of the SCR catalyst is predetermined by temperature gradient of the SCR catalyst.

After dividing blocks, each reaction model module is applied (S140) and required ammonia amount of each block is calculated (S150).

The calculating required ammonia amount of each block, as shown in FIG. 5, can be calculated by applying each temperature (T.SCR) of each block into the map of loadable ammonia amount per volume (S151) and using substantial volume of each block (S152).

Also, current loaded ammonia amount of the SCR catalyst 10 is calculated by using inflowing ammonia amount (NH3.In) into the SCR catalyst 10, inflowing NOx amount (NOx.In) into the SCR catalyst and reducing NOx rate (S153), and required ammonia amount of each block of the SCR catalyst 10 is calculated from difference of the loadable ammonia amount of each block (from S152) and current loaded ammonia amount (from S153).

And then, total required ammonia amount of the SCR catalyst 10 is calculated by adding the required ammonia amount of each block of the SCR catalyst 10 (S160).

After calculating the total required ammonia amount of the SCR catalyst 10 and then injecting the urea amount from the dosing module 20 is controlled.

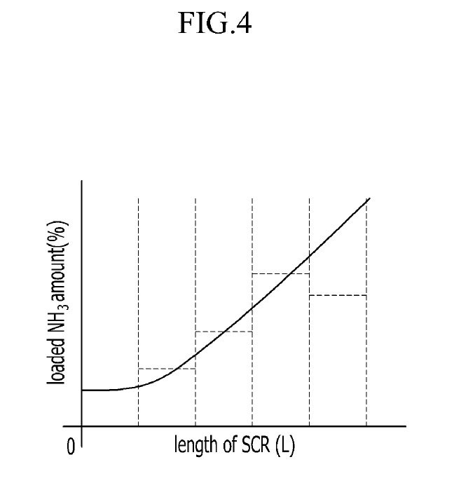

FIG. 4 is a graph showing an ammonia loading amount along a SCR catalyst length direction according to various embodiments of the present invention.

As shown in FIG. 4, loading amount of the ammonia along length direction of the SCR catalyst 10 can be confidentially uniformly maintained and thus reduction rate of NOx can be increased and slip can be prevented.

For convenience in explanation and accurate definition in the appended claims, the terms “front” or “rear”, “inside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A control method of ammonia loading amount for SCR system comprising:
receiving data from sensors disposed forward and rearward of a SCR catalyst;
dividing SCR catalyst into a plurality of block according to temperatures of an inlet and outlet of the SCR catalyst, wherein the blocks have each temperature ranges;
calculating required ammonia amount of each block of the SCR catalyst;
calculating total required ammonia amount of the SCR catalyst by adding required ammonia amount of each block of the SCR catalyst; and
controlling the ammonia loading amount for SCR system.

2. The control method of claim 1, wherein the dividing SCR catalyst into a plurality of blocks is accomplished according to a predetermined temperature model along length direction of the SCR catalyst.

3. The control method of claim 1, wherein the calculating required ammonia amount of each block of the SCR catalyst comprises:
calculating loadable ammonia amount of each block of the SCR catalyst from a predetermined map according to the temperature of each block;
calculating current loaded ammonia amount of the SCR catalyst using inflowing ammonia amount into the SCR catalyst, inflowing NOx amount into the SCR catalyst and reducing NOx rate; and
calculating the required ammonia amount of each block of the SCR catalyst from difference of the loadable ammonia amount of each block and current loaded ammonia amount.

4. The control method of claim 1, wherein the receiving data from sensors comprises:
ammonia amount, resolved from urea supplying to the SCR catalyst;
NOx amount within exhaust gas; and
temperature at inlet and outlet of the SCR catalyst respectively.
